(19) United States
(12) Patent Application Publication
(10) Pub. No.: US 2023/0210276 A1
(43) Pub. Date: Jul. 6, 2023

(54) Foldable Carry Cot

(71) Applicant: Silver Cross (IP) Limited, Skipton (GB)

(72) Inventors: Philip Jeffrey Taylor, Skipton (GB); Luke Patrick Mallinder, Skipton (GB)

(73) Assignee: Silver Cross (IP) Limited, Skipton (GB)

(21) Appl. No.: 18/045,628

(22) Filed: Oct. 11, 2022

(30) Foreign Application Priority Data
Oct. 12, 2021 (GB) 2114593.3

(51) Int. Cl. A47D 9/00; A47D 13/02

(52) U.S. Cl. CPC A47D 9/005; A47D 13/02

(57) ABSTRACT

A foldable carry cot for carrying an infant, the foldable carry cot comprising: a base member; a foldable sidewall flexibly coupled to the base member, the foldable sidewall being configured to move between a functional configuration that provides a sidewall to the foldable carry cot such that the foldable carry cot is suitable carrying an infant, and a folded configuration wherein the foldable sidewall is configured to fold inwardly.

### CROSS REFERENCE TO RELATED APPLICATIONS

This application claims the benefit of GB 2114593.3, filed Oct. 12, 2021, which is hereby incorporated by reference.

### FIELD

The present invention relates to a foldable carry cot for carrying an infant.

### BACKGROUND

Infants, particularly infants between 0-12 months old, are generally laid flat on their backs to sleep and to rest. It is well appreciated that infants require significant amounts of sleep and rest to promote healthy physical and cognitive development, and thus it is imperative that the infant is provided with a suitable environment to sleep and rest in when required. Moreover, in order to promote proper organ and skeletal development, it is important that infants are placed in this lie-flat position, particularly for spine development. More upright positions, such as a seated position, puts undue strain on the fragile skeleton and organs of the infant, and may lead to developmental abnormalities. Moreover, it is understood that lying infants flat can promote regular and healthy breathing, and can allow the infant to move their limbs freely to explore their environment, and thus promote cognitive development.

However, it is not always practical to provide means for an infant to lie on their back, particularly when the infant is taken outside of the home environment. For this reason, it is desirable to provide a portable carry cot which the infant can be laid in when outside of the home.

Carry cots are generally large and bulky objects, owing to the need to provide (i) sufficient space for the infant to lie and move in; (ii) adequate shielding to protect the infant from the surrounding environment; and (iii) the need for the carry cot to be structurally stable such that the infant is safe therein. As such, carry cots may comprise large sidewalls and a cover to protect the infant from environmental factors such as dust, wind, cold weather, and the like. Moreover, the carry cot may be provided with a hood to protect the infant from environmental factors such as direct sunlight, the wind, and the like. The structural integrity required of the carry cot may be provided by means of a frame.

For carry cots to be taken outside of the home, it is desirable that the carry cot can be easily transported, stored and assembled when required. In particular, it is desirable that the carry cot can be stored away easily (e.g. in a cupboard, under the stairs, in the boot of a motor vehicle), but may also be readily assembled quickly when required.

It is an object of the present invention to obviate or at least ameliorate one or more of the above-mentioned problems.

### SUMMARY

According to a first aspect of the invention there is provided a foldable carry cot for carrying an infant, the foldable carry cot comprising a base member and a foldable sidewall flexibly coupled to the base member, the foldable sidewall being configured to move between a functional configuration that provides a sidewall to the foldable carry cot such that the foldable carry cot is suitable for carrying an infant, and a folded configuration wherein the foldable sidewall is configured to fold inwardly. Within the context of the present invention, flexibly coupled means that at least a portion of the foldable sidewall can move relative to the base member. For instance, the foldable sidewall is configured to pivot relative to the base member to fold inwardly. By inwardly, it is understood that the sidewall is folded into the footprint of the base member rather than being folded outwardly where it would extend outside the footprint of the base member during and/or after folding. Preferably, the sidewall is configured such that it comprises no moving components, such as internal sliding or rotating components, and relies upon folding to move between a functional configuration and a folded configuration.

The foldable carry cot is suitable for carrying an infant, in particular an infant between 0-12 months old at which age it is important that the infant rests and sleeps lying down for the reasons outlined above. The foldable carry cot can readily move between a functional configuration that is suitable for use with the infant, and a folded configuration that is suitable for storing the foldable carry cot and/or transporting the foldable carry cot. In the functional configuration, the foldable sidewall extends upwardly relative to the base member such that the infant is surrounded on four sides by the foldable sidewall. In the folded configuration, the foldable sidewall folds inwardly such that the foldable sidewall is substantially flat to the base member (i.e. such that the foldable carry cot is substantially flat).

Advantageously, the foldable carry cot is structurally stable in the functional configuration and can be easily transported and stored in the folded configuration. Advantageously, the foldable carry cot can be easily moved from the functional configuration to the folded configuration and from the folded configuration to the functional configuration. Advantageously, the foldable travel cot is lightweight such that an adult is able to carry the foldable travel cot and an infant contained within it. The sidewall is preferably free from a continuous rigid support member circumscribing an upper periphery of the sidewalls. The sidewall may be provided with internal members, which may be resilient members, that are configured to provide structure to portions of the sidewall, such as the sides, head portion (the portion of the wall closest to the infant's head in use), and/or the food portion (the portion of the wall closest to the infant's feet in use). Such internal members may comprise resilient rods, such as polypropylene rods. These may be retained in pockets provided in the sidewall and may be tensioned therein to provide a degree of tautness to the sidewall.

In embodiments, the foldable sidewall in the functional configuration is absent of folds or creases such that the foldable sidewall provides a continuous inner surface.

Advantageously, providing a continuous inner surface to the infant prevents the infant from pulling at flaps or creases within the travel cot. This may improve safety for the infant and/or prolong a life of the foldable travel cot. Providing a continuous inner surface without flaps or creases may make the foldable travel cot easier to clean, as dirt cannot be trapped within flaps or creases. In addition, this may allow the amount of fabric used to form the sidewalls to be reduced as compared to carry cots which rely on overlapping portions of the sidewall and reversibly attaching folded sections to one another to provide the structure of the sidewall in the functional configuration.

In embodiments, the foldable sidewall is coupled to the base member to provide tension in the foldable sidewall such that the foldable sidewall is freely upstanding from the base member in the functional configuration. Expressed differently, freely upstanding means without support from fastening means such as pop rivets in corners (i.e. between end wall portions and side wall portions) of the foldable sidewall. If desired, the foldable sidewall may, in embodiments, be provided with fastening means to secure the foldable sidewall to one or more features of a hood member. For instance, as will be described in more detail below, the foldable sidewall may be reversibly fastened to the foldable hood; and/or reversibly fastened to the first and/or second arms comprised in the hood member. The foldable sidewall may also be reversibly fastening to the cover member, if desired. Such reversibly fastening means (e.g. pop rivets, zips and the like) are described in more detail below, but can optionally be provided to give additional structural integrity to the carry cot in the functional configuration, and more particularly to the foldable sidewall. Provision of such reversible fastening means can also advantageously avoid the situation where the infant pulls the sidewalls inwardly towards a folded configuration.

Advantageously, the freely upstanding sidewall enables the foldable travel cot to move between the functional configuration and the folded configuration more quickly and/or easily. For example, because there is no need to fasten/unfasten fastening means in the corners of the foldable sidewall. Advantageously, the tension in the foldable sidewall causes the sidewall to move from the folded to the functional configuration if the foldable sidewall is not directly/indirectly fastened (i.e. secured) to the base member and/or itself. Consequently, the foldable travel cot may be moved from the folded to the functional configuration using one hand, e.g. by removing fastening of the sidewall to the base member and/or itself. The fastening of the sidewall in the folded configuration to the base member may be provided by means of by at least one pop rivet. The fastening of the sidewall to itself in the folded configuration may be provided by means of at least one pop rivet.

In embodiments, the foldable sidewall is irreversibly secured (i.e. integrally connected to) to the base member. For example, by stitching or glue. This prevents the sidewall from becoming detached from the base and may be configured to provide some pre-tensioning of the sidewall into the functional configuration. As such, the sidewall may be connected to the base such that the sidewall naturally tends towards the functional configuration. Of course, it will be appreciated that in other embodiments, the sidewall is configured such that it naturally tends towards the folded configuration.

In embodiments, the foldable sidewall is precluded from folding outwardly. In other words, the foldable sidewall cannot be folded outwardly into a ‘net’ (e.g. a net of a polyhedron) or ‘template’ configuration that is substantially flat. This reduces the risk of the infant from being able to roll or fall out of the carry cot as would be the case where the sidewall able to fold outwardly.

The base member may comprise a peripheral lip extending upwardly from the base member to define a recess. Expressed differently, the base member may comprise a tray. The foldable sidewall may be irreversibly secured to an inner surface of the peripheral lip (i.e. by stitching and/or glue and/or welding) such that the peripheral lip precludes the foldable sidewall from folding outwardly. Advantageously, having the foldable sidewall precluded from folding outwardly improves structural stability of the foldable travel cot in the functional configuration, such that the infant is more securely contained within the foldable travel cot—this may improve safety for the infant. Advantageously, improving structural stability of the foldable travel cot by precluding the foldable sidewalls from folding outwardly may prolong the life of the foldable travel cot.

In embodiments, the foldable sidewall comprises a pair of opposing end wall portions and a pair of opposing side wall portions. Each of the end wall portions and side wall portions are flexibly coupled to the base member.

In use, one end wall portion is positioned proximate a head of the infant and is called a head end of the foldable carry cot. In use, the opposing end wall portion is positioned proximate the feet of the infant and is called a foot end of the foldable carry cot.

In embodiments, the pair of opposing end wall portions are configured to fold inwardly onto the base member, and the pair of opposing side wall portions are configured to fold onto the opposing end wall portions.

Advantageously, this enables the foldable sidewalls to be substantially flat to the base member, which improves storing and/or transporting of the foldable carry cot.

In embodiments, the foldable sidewall is reinforced, such that in the functional configuration the sidewalls are upstanding relative to the base member to provide the carry cot sidewalls.

The foldable sidewall may be reinforced using reinforcement sheets and/or rods. For example, the foldable sidewall may be reinforced using one or more polypropylene sheets. The reinforcement sheets are preferably contained within one or more pockets with the sidewall. The reinforcement sheets are preferably resilient. The reinforcement sheets are preferably pliable. The reinforcement sheets provide support to the sidewall to assist with it standing upright when in the functional configuration.

In embodiments, the foldable carry cot may comprise (reversible) fastening means for securing the foldable sidewall in the folded configuration. The fastening means may be provided on the outer sides of the foldable side walls, such that they are inaccessible to the infant when in use in the functional configuration. Moreover, as the foldable sidewall is folded inwardly, the fastening means then become available to secure the foldable sidewall in a folded configuration.

The fastening means may comprise at least one of: a zip, Velcro, pop rivets, string, magnets, a strap and buckle, and the like.

In embodiments, the foldable sidewall comprises a continuous fabric sheet flexibly coupled to the base member.

The continuous fabric sheet may be flexibly coupled to the base member using stitching and/or glue and/or welding, or the like.

In embodiments, the continuous fabric sheet is constructed from at least two sheets of fabric, such that the continuous fabric sheet has at least one pocket between the at least two sheets of fabric. Expressed differently, the pocket comprises a gap between the two continuous fabric sheets. One pocket may be defined between the two continuous fabric sheets or multiple pockets may be defined between the two continuous fabric sheets. For example, multiple pockets may be separated by stitching or glue between the two continuous fabric sheets. In embodiments, multiple pockets are provided, e.g. at least two pockets, at least three pockets, at least four pockets. Preferably, at least four pockets are provided, each of the four pockets corresponding to a pair of opposing end wall portions and a pair of opposing side wall portions comprised in the foldable sidewall.

In embodiments, the at least one pocket is configured to accommodate at least one reinforcing member. Preferably, at least four pockets are provided, each of the four pockets corresponding to a pair of opposing end wall portions and a pair of opposing side wall portions comprised in the foldable sidewall, wherein each of the four pockets comprises at least one reinforcing member (e.g. a polypropylene sheet).

Advantageously, having multiple pockets may enable the reinforcing members to be held in place relative to the continuous fabric sheet. This may prevent the reinforcing members from moving within the sidewalls. Reinforcing members moving within the sidewalls may be unwanted as this may prevent the sidewalls from folding into the folded configuration. The reinforcing members may be retained only by the pockets and may additionally or alternatively be retained by fixing means, such as gluing, welding, or stitching.

In embodiments, the foldable sidewall comprises: a pair of opposing end wall portions including a first end wall portion and a second end wall portion, wherein the first end wall portion comprises a first end wall reinforcing member in a first end wall pocket, and the second end wall portion comprises a second end wall reinforcing member in a second end wall pocket; a pair of opposing side wall portions, including a first side wall portion and a second side wall portion, wherein the first side wall portion comprises a first side wall reinforcing member in a first side wall pocket, and the second side wall portion comprises a second side wall reinforcing member in a second side wall pocket.

In embodiments, the foldable carry cot further comprises a hood member, the hood member being pivotally connected to the base member.

Advantageously, the hood member may protect the infant from the environment (e.g. sun, wind, rain) while enabling an adult carrying the foldable carry cot and the infant to see each other. The hood member may be positioned at the head of the foldable carry cot. Advantageously, the hood member may be windproof and/or waterproof.

In embodiments, the hood member comprises a foldable hood, optionally wherein the foldable hood comprises a fabric. The foldable hood may comprise at least one reinforcing member for providing structural integrity to the foldable hood. The hood may include a transparent window to allow the infant to be viewed therethrough.

In embodiments, the foldable carry cot further comprises (reversible) fastening means for securing the foldable hood to the foldable sidewall and/or to the base member. Typically, the foldable hood is secured to the foldable sidewall. The foldable hood may comprise at least one reinforcing member, such as a polypropylene rod, having a complimentary shape to the outside of the foldable sidewall. The at least one reinforcing member is provided in the foldable hood at the position to be secured to the foldable sidewall. As such, when the foldable sidewall is secured to the foldable hood, the foldable hood provides additional structural integrity to the foldable side wall when in the functional configuration.

The fastening means may comprise at least one of: a zip, Velcro, pop rivets, magnets, or like reversible fastening.

In embodiments, the hood member comprises a first arm and a second arm, wherein the first arm and second arm are each pivotally connected to the base member such that the first arm and second arm can pivot relative to the base member.

In embodiments, the first arm and second arm are arranged on opposing sides of the base member.

In embodiments, the first arm and the second arm each have an angled arrangement, such that a first end of the first arm is offset relative to a second end of the first arm that is pivotally connected to the base member, and such that a first end of the second arm is offset relative to a second end of the second arm that is pivotally connected to the base member.

Expressed differently, instead of the first arm and the second arm being perfectly straight, each arm may be kinked part of the way along a length of the arms. The first arm and the second arm may be kinked such that when the first end of the first arm and the first end of the second arm extend upwardly relative to the base member, the second end of the first arm and the second end of the second arm are angled towards the head of the foldable carry cot. The first arms and second arms may extend upwardly from the base member by a distance that is equal to the height of the sidewalls when in the functional configuration.

In embodiments, the hood member further comprises a third arm pivotally connected to the first arm, and a fourth arm pivotally connected to the second arm, such that the third arm can pivot relative to the first arm and the fourth arm can pivot relate to the second arm.

In embodiments, the third arm and fourth arm are connected to provide a handle. The third and fourth arms may be unitary.

Advantageously, because the first arm and the second arm each have the angled arrangement, when in the folded configuration, the third and fourth arm protrude above an upper surface of the foldable sidewalls (i.e. which are folded) less than if the first arm and the second arm did not have the angled arrangement.

Expressed differently, the hood member comprises a double pivot. On one side of the foldable carry cot, the double pivot comprises the pivot between the base member and the first arm, and the pivot between the first arm and the third arm. On another side of the foldable carry cot, the double pivot comprises the pivot between the base member and the second arm, and the pivot between the second arm and the fourth arm. The double pivot in combination with the angled arrangement enables the third and fourth arms to pivot backwards relative to the first arm and the second arm such that the third and fourth arms lie substantially parallel to the base member (but the first and second arms lie substantially antiparallel to the third and fourth arms). This improves storing and/or transporting of the foldable carry cot. Additionally, in the folded configuration, the handle lies flat to the foldable sidewalls (i.e. which are folded) and the foldable hood folds between the handle and the foldable sidewalls.

Because the first arm and the second arm each have the angled arrangement, when in the functional configuration, the handle is offset relative to the pivot between the base member and the first and second arms. Expressed differently, the handle is closer to the head of the foldable carry cot than the foot of the foldable carry cot. Advantageously, this causes the hood to cover less than half of the infant, which enables an adult carrying the foldable carry cot and the infant to see each other more easily than if the first arm and the second arm did not have the angled arrangement.

In embodiments, the foldable carry cot further comprises a releasable locking mechanism, the releasable locking mechanism being configured to lock the hood member in a locked position, and to release the hood member such that the hood member can pivot relative to the base member.

In embodiments, the releasable locking mechanism comprises a locking release, wherein actuation of the locking release releases the hood member.

In embodiments, the locking release comprises a locking pin.

In embodiments, the locking pin is biased towards an engaged position that locks the hood member in the locked position, optionally wherein the locking pin is biased towards the engaged position by means of a resilient member, for example a spring.

In embodiments, the releasable locking member further comprises a locking member configured to engage with the locking pin in the engaged position, and to disengage from the locking pin upon actuation of the locking release such that the hood member is released.

In embodiments, the locking member comprises a gear wheel.

In embodiments, the gear wheel is arranged co-axially with the pivotal connection between the hood member and the base member.

In embodiments, the gear wheel comprises a plurality of teeth arranged on an inner circumferential surface of the gear wheel.

In embodiments, the foldable carry cot further comprises a second releasable locking mechanism, the second releasable locking member being configured to lock the position of the third arm and fourth arm relative to the first arm and second arm, and to release the third arm and the fourth arm such that the third arm and fourth arm can pivot relative to the first arm and second arm.

Advantageously, the first and the second releasable locking mechanisms enable the foldable carry cot to be releasably locked into either the functional configuration or the folded configuration. Advantageously, the first and the second releasable locking mechanisms enable the foldable carry cot to be moved between the functional configuration and the folded configuration by releasing then subsequently locking the first and the second releasable locking mechanisms.

In embodiments, the second releasable locking mechanism is as defined in relation to the first releasable locking mechanism.

In embodiments, the second releasable locking mechanism comprises a push-release button.

In embodiments, the foldable carry cot further comprises (reversible) fastening means for securing the foldable sidewall to the hood member (e.g. to the first and second arms and/or to the third and fourth arms comprised in the hood member). In embodiments, the second releasable locking mechanism comprised in the hood member comprises fastening means on an inside surface for securing the hood member to the foldable sidewall.

The fastening means may comprise at least one of: a zip, Velcro, pop rivets, magnets, and the like.

In embodiments, the base member comprises a rigid base member.

In embodiments, the base member comprises a peripheral lip extending upwardly from the base member to define a recess.

In embodiments, the recess is suitable for accommodating a mattress for an infant.

In embodiments, the recess is suitable for at least partially accommodating the foldable reinforced sidewall when in the folded configuration.

In embodiments, the foldable carry cot further comprises a cover member, the cover member being connected to the flexible sidewalls and suitable for providing cover to at least a portion of the infant in the functional configuration. In use, the cover may be arranged to cover a lower portion of the infant (i.e. the foot end of the foldable carry cot).

Advantageously, the cover may protect the infant from the environment (e.g. sun, wind, rain). Advantageously, the cover may be windproof and/or waterproof. Advantageously, the cover may comprise at least one reinforcing member, such as a polypropylene rod extending around the periphery of the cover, to improve the integrity of the cover, and in turn to improve the integrity of the foldable carry cot sidewall when connected thereto in the functional configuration.

In embodiments, the cover member comprises a fabric.

In embodiments, the foldable carry cot further comprises (reversible) fastening means for securing the cover member to the foldable sidewall. In embodiments, the at least one reinforcing member is provided in the periphery of the cover member, at the point which the cover is to be secured to the foldable sidewall.

The fastening means may comprise at least one of: a zip, Velcro, pop rivets, magnets, and the like.

According to a second aspect of the invention, there is provided a foldable carry cot for carrying an infant, the foldable carry cot comprising a base member and a hood member. The hood member comprises a first arm and a second arm, wherein the first arm and second are each pivotally connected to the base member such that the first arm and second arm can pivot relative to the base member, the hood member further comprising a third arm pivotally connected to the first arm, and a fourth arm pivotally connected to the second arm, such that the third arm can pivot relative to the first arm and the fourth arm can pivot relate to the second arm.

The advantages of the second aspect of the invention are identical to the advantages of the first aspect of the invention.

In embodiments, the first arm and the second arm each have an angled arrangement, such that a first end of the first arm is offset relative to a second end of the first arm that is pivotally connected to the base member, and such that a first end of the second arm is offset relative to a second end of the second arm that is pivotally connected to the base member.

The advantages of the angled arrangement are identical to the advantages of the angled arrangement as described in relation to the first aspect of the invention.

Features mentioned above in accordance with any aspect of the present disclosure or below relating to any specific embodiment of the disclosure might be used, either alone or in combination with any other defined feature, in any other aspect or embodiment or to form a further aspect or embodiment of the disclosure.

### BRIEF DESCRIPTION OF THE DRAWINGS

Embodiments of the invention will now be described, by way of example only, with reference to the accompanying schematic drawings, in which:

FIGS. 1A and 1B show a side view of a foldable carry cot according to the present invention. FIG. 1B shows a full view of the foldable carry cot as a hood member of the present invention is stowed from a functional configuration to a folded configuration (functional configuration indicated by lighter shading; direction of arrow indicates direction of movement of the hood member). FIG. 1A shows an enlarged view of a second releasable locking mechanism used to pivot the third arm of the hood member relative to the first arm, and the second arm of the hood member relative to the fourth arm;

FIG. 2 shows a top-down view of the foldable carry cot with the hood member in the stowed configuration. The double headed arrow indicates fastening means can be unfastened to allow the cover member to be removed;

FIG. 3 shows an isometric enlarged view of a fastening means used to fasten and unfasten the cover member to foldable sidewalls of the foldable carry cot;

FIGS. 4A, 4B and 4C show a top-down view of the foldable carry cot as the foldable hood is unfastened from the foldable sidewall. FIG. 4B shows a full view, FIG. 4A shows an enlarged view of one side of the carry cot and FIG. 4C shows an enlarged view of an opposing side of the carry cot;

FIG. 5 shows a top-down view of the foldable carry cot after the foldable sidewalls have been unfastened from the second releasable locking mechanism;

FIG. 6 shows an isometric view of the foldable carry cot as end wall portions of the sidewalls are being folded;

FIG. 7 shows an isometric view of the foldable carry cot as side wall portions of the sidewalls are being folded over the end wall portions;

FIGS. 8A and 8B show an isometric view of fastening the sidewalls of the foldable carry cot together such that the sidewalls cannot unfold. FIG. 8A shows a full view and FIG. 8B shows an enlarged view of a fastening means for fastening the side wall portions together;

FIGS. 9A and 9B show an isometric view of releasing a first releasable locking mechanism of the foldable carry cot and moving first and second arms of the present invention relative to the base member. FIG. 9B shows a full view and FIG. 9A shows an enlarged view of the first releasable locking mechanism;

FIGS. 10A and 10B show an isometric view of securing the first releasable locking mechanism of the foldable carry cot after the first and second arms of the present invention have been moved. FIG. 10A shows a full view and FIG. 10B shows an enlarged view of the first releasable locking mechanism;

FIG. 11 shows an isometric view of the foldable carry cot in the folded configuration;

FIG. 12 shows an isometric view of the foldable carry cot without the foldable sidewalls, foldable hood, mattress or cover, such that movement of the present invention between the folded and the functional configuration can be better understood;

FIG. 13 shows an isometric view of the foldable carry cot of FIG. 12 in a partially-folded configuration;

FIG. 14 shows an isometric view of the foldable carry cot of FIG. 12 in a folded configuration;

FIG. 15 shows a side view of the foldable carry cot of FIG. 12;

FIG. 16 shows a side view of the foldable carry cot of FIG. 13;

FIG. 17 shows a side view of the foldable carry cot of FIG. 14;

FIG. 18 shows an enlarged side view of the first arm and first releasable locking mechanism in a locked state;

FIG. 19 shows an enlarged side view of the first arm and first releasable locking mechanism in an unlocked state.

### DETAILED DESCRIPTION

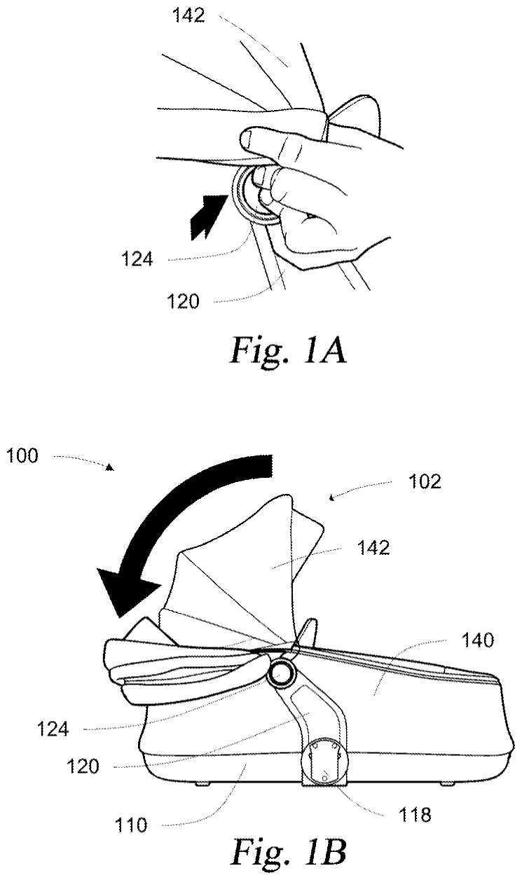

The present invention provides a foldable carry cot 100 for carrying an infant (FIGS. 1-11). Additional drawings to aid in understanding the foldable carry cot 100 are provided in FIGS. 12-19.

Those skilled in the art will appreciate that foldable carry cots 100 are capable of being converted from a functional configuration suitable for use with an infant, into a more compact form, allowing the carry cot 100 to be stored more easily. As such, the foldable carry cot 100 according to the present invention has a functional configuration suitable for use with an infant, and a folded configuration, suitable for storage and/or transport of the carry cot 100. Those skilled in the art will further appreciate that the foldable carry cot 100 according to the present invention may have a plurality of intermediate configurations as the foldable carry cot 100 moves between the functional and folded configurations.

Within the context of the present invention, an infant is typically from 0-18 months, more particularly from 0-12 months, and more particularly still 0-6 months old. The foldable carry cot 100 is provided with a base member 110 upon which the infant can be laid flat. As described in detail above, it is important for infants of this age to be laid flat to assist in their physical and cognitive development.

The foldable carry cot comprises a base member 110, a foldable sidewall 140, an optional mattress 144, an optional cover 146, an optional hood member 102, and an optional fastening means 150.

The base member 110 is rigid and comprises a peripheral lip extending upwardly from the base member 110 to define a recess that is suitable for accommodating the optional mattress 144. Expressed differently, the base member 110 comprises a tray. The foldable sidewall is irreversibly secured to an inner surface of the peripheral lip such that the peripheral lip precludes the foldable sidewall 140 from folding outwardly. The base member 110 comprises an optional first vent 132 and an optional second vent 133, which are at opposite ends of the base member 110. The first vent 132 and the second vent 133 are configured to enable ventilation of the foldable carry cot 100.

The foldable sidewall 142 comprises a pair of opposing end wall portions and a pair of opposing side wall portions. In use, one end wall portion is positioned proximate a head of the infant and is called a head end of the foldable carry cot 100. In use, the opposing end wall portion is positioned proximate feet of the infant and is called a foot end of the foldable carry cot 100.

The hood member 102 comprises a first releasable locking mechanism 118, 119, a second releasable locking mechanism 124, 125, a first arm 120, a second arm 122, a third arm 126, a fourth arm 128, a handle 130, and a hood 142.

The foldable sidewall 140 is flexibly and irreversibly coupled (i.e. secured) to the base member 110. In the functional configuration (as shown in FIG. 1B), the foldable sidewalls 140 extend upwardly relative to the base 100 member such that the infant is surrounded on four sides by the foldable sidewalls 140. Because the sidewalls 140 are coupled to the base member 110, the pair of opposing end wall portions and the pair of opposing side wall portions are flexibly coupled to the base member 110.

The coupling of the sidewalls 140 to the base member 110 results in tension in the foldable sidewall 140, which causes the foldable sidewalls 140 to be freely upstanding from the base member 110 in the functional configuration. In the functional configuration, the foldable sidewall is absent of folds or creases and provides a continuous inner surface.

The foldable sidewall 140 comprises a continuous fabric sheet flexibly coupled to the base member 110. The foldable sidewall is configured such that the sides fold inwardly rather than outwardly such that the walls are not able to be pushed outwardly allowing the infant to roll out. The continuous fabric sheet is constructed from at least two sheets of fabric, such that the continuous fabric sheet has four pockets between the two sheets of fabric. Expressed differently, the pocket comprises a gap between the two continuous fabric sheets. The pockets are separated, such as by stitching, between the two continuous fabric sheets. Each of the four pockets is configured to hold a reinforcing member. The first end wall portion comprises a first end wall reinforcing member in a first end wall pocket, the second end wall portion comprises a second end wall reinforcing member in a second end wall pocket, the first side wall portion comprises a first side wall reinforcing member in a first side wall pocket, and the second side wall portion comprises a second side wall reinforcing member in a second side wall pocket.

The cover member 146 is connected to a top of the flexible sidewalls 140 by a fastening means in the form of a zip. The zip extends around three sides of the sidewall 140 including both side wall portions and the foot end of the foldable carry cot 100. Expressed differently, the cover member is suitable for providing cover to at least a portion of the infant when the foldable carry cot 100 is in the functional configuration. The cover member 146 comprises a fabric. The cover member 146 may comprise a polypropylene rod (not illustrated) extending along one or more sides sides of the cover member 46, such as corresponding to the three sides of sidewall 140 comprising a zip mentioned above, to provide structural integrity to the cover member 146, and also to provide additional structural integrity to the foldable sidewall when the cover member is attached thereto.

The mattress 144 is arranged such that a lower surface of the mattress 144 is in contact with an upper surface of the base member 110. The sidewalls 140 extend above the mattress 144. The mattress 144 extends over the base member 110 to the peripheral lip such that in use, the infant is unable to contact the base member 110.

The hood member 102 is pivotally connected to the base member 110. The hood member 102 comprises a foldable hood 142 comprising a fabric. The foldable hood 142 further comprises fastening means in the form of pop rivets, zips or such like for securing the foldable hood 142 to the sidewalls 140. The foldable hood 142 is attached to both sidewalls proximate the first releasable locking mechanisms 118, 119. The foldable hood 142 extends from the first releasable locking mechanism 118 to the first releasable locking mechanism 119 around an edge of the foldable sidewall 140 and around the head of the foldable carry cot 100. The foldable hood 142 comprises at least one reinforcing member such as a polypropylene rod, which extends around the periphery of the portion of the foldable hood that is secured to sidewalls 140, thus providing additional structural integrity to the foldable hood 142 and to the sidewalls 140 in the functional configuration.

In use, this arrangement enables the hood member 102 to protect the infant from the environment (e.g. sun, wind, rain) while enabling an adult carrying the foldable carry cot 100 and the infant to see each other.

The first arm 120 and the second arm are each pivotally connected to the base member 110 by the first releasable locking mechanisms 118, 119 such that the first arm 120 and the second arm 122 can pivot relative to the base member 110. The first arm 120 is pivotally connected to the base member 110 by the first releasable locking mechanism 118 and the second arm 122 is pivotally connected to the base member 110 by a separate first releasable locking mechanism 119. The first releasable locking mechanisms 118,119 are arranged on opposing sides of the base member 110. As such, the first arm 120 and the second arm 122 are arranged on opposing sides of the base member 110 such that the first arm 120 is attached to a side of the base member 110 near one side wall portion and the second arm 122 is attached to a side of the base member 110 near the opposing side wall portion.

The first releasable locking mechanism 118, 119 is configured to lock the hood member 102 in a locked position, and to release the hood member 102 such that the hood member 102 can pivot relative to the base member 110.

The first arm 120 and the second arm 122 each have an angled arrangement, such that a first end of the first arm 120 is offset relative to a second end of the first arm 120 that is pivotally connected to the base member 110, and such that a first end of the second arm 122 is offset relative to a second end of the second arm 122 that is pivotally connected to the base member 110.

Expressed differently, instead of the first arm 120 and the second arm 122 being straight, each arm 120, 122 is kinked part of the way along a length of the arms 120, 122. The first arm 120 and the second arm 122 are kinked such that when the first end of the first arm 120 and the first end of the second arm 122 extend upwardly relative to the base member 110, the second end of the first arm and the second end of the second arm are angled towards the head of the foldable carry cot 100.

The third arm 126 is pivotally connected to the first arm 120 by the second releasable locking mechanism 124, and a fourth arm 128 pivotally connected to the second arm 122 by the second releasable locking mechanism 125, such that the third arm 126 can pivot relative to the first arm 120 and the fourth arm 128 can pivot relate to the second arm 122. The third arm 126 and fourth arm 128 are connected to provide the handle 130. The handle 130 is provided upwards of the base member 110 to enable the foldable carry cot 100 to be carried.

The second releasable locking mechanism 124, 125 is configured to lock the position of the third arm 126 and fourth arm 128 relative to the first arm 120 and second arm 122, and to release the third arm 126 and the fourth arm 128 such that the third arm 126 and fourth arm 128 can pivot relative to the first arm 120 and second arm 124.

In the functional configuration, the fastening means 150 is arranged on an outside of the side wall portions such that in use, the infant cannot contact the fastening means 150. The fastening means is in the form of a pop rivet that can be fastened or unfastened by closing or opening the pop rivet.

FIGS. 1-11 show steps to move the foldable carry cot 100 from the functional configuration to the folded configuration. Those skilled in the art will appreciate that to move the foldable carry cot 100 from the folded configuration to the functional configuration, the steps in FIGS. 1-11 should be followed in reverse order.

FIGS. 1A and 1B show a side view of a foldable carry cot 100 according to the present invention. FIG. 1B shows a full view of the foldable carry cot 100 as a hood member 102 of the present invention is stowed from a functional configuration. In FIG. 1B the hood member 102 is shown in a functional configuration in light grey and in a stowed configuration in dark grey. FIG. 1A shows an enlarged view of a second releasable locking mechanism 124 used to move the foldable carry cot 100 between the functional configuration and the stowed configuration.

The second releasable locking mechanism 124 comprises a push-release button operable to allow rotation between the first arm 120 and the third arm 126 while the push-release button is pressed and to lock otherwise.

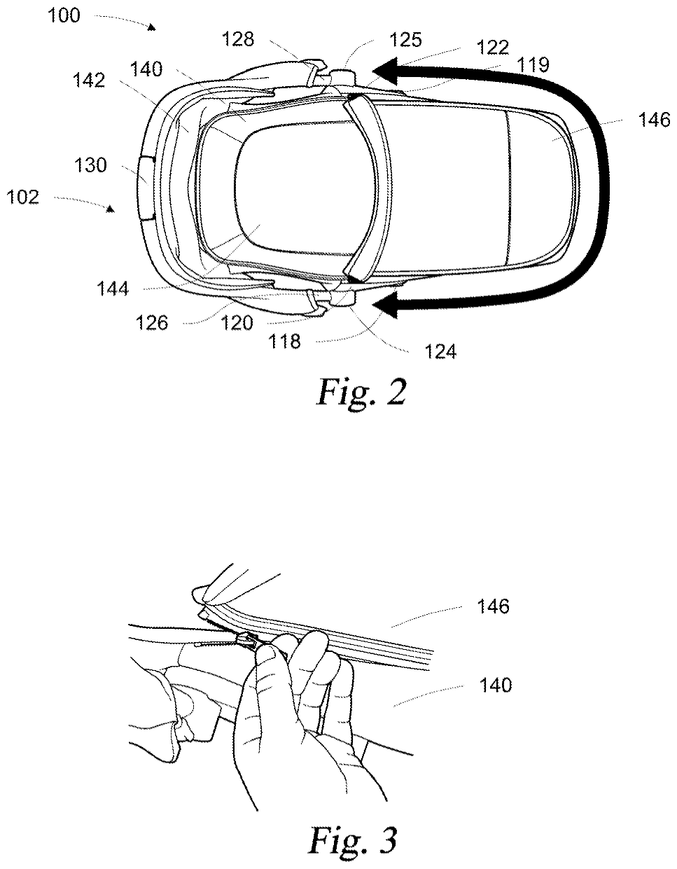

FIG. 2 shows a top-down view of the foldable carry cot 100 with the hood member 102 in the stowed configuration.

FIG. 3 shows an isometric enlarged view of a fastening means in the form of a zip used to fasten and unfasten the cover 146 to the foldable sidewalls 140 of the foldable carry cot 100. FIG. 3 shows unzipping of the cover 146 such that the cover 146 may be removed from the foldable carry cot 100.

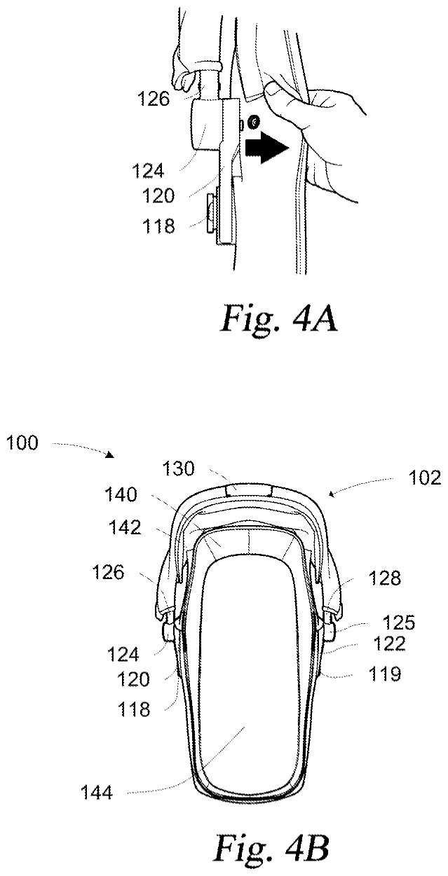

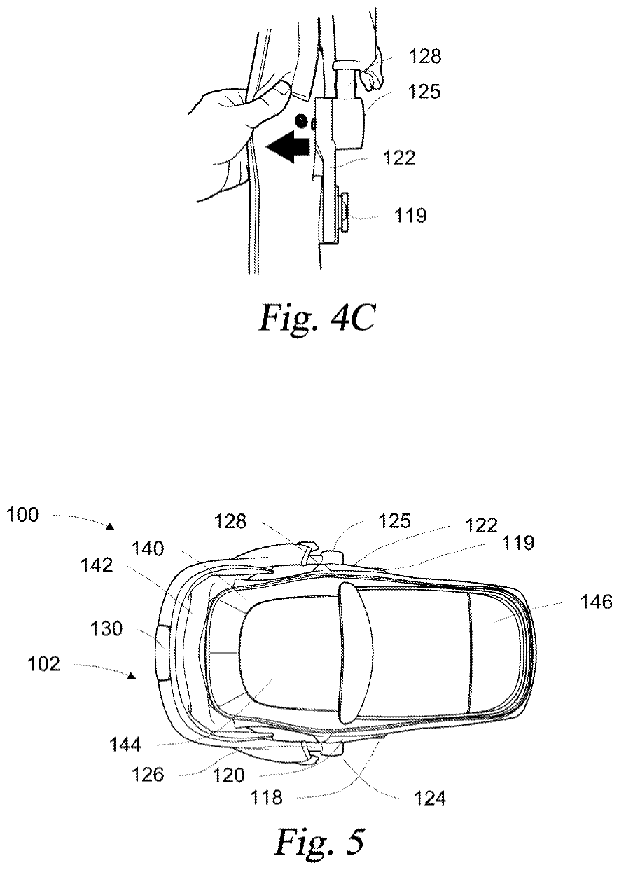

FIGS. 4A, 4B and 4C show a top-down view of the foldable carry cot 100 as the foldable hood 142 is unfastened from the base member 110. FIG. 4B shows a full view, FIG. 4A shows an enlarged view of one side of the present invention and FIG. 4C shows an enlarged view of an opposing side of the present invention.

Unfastening the foldable hood 142 from the base member 110 enables the foldable carry cot 100 to be moved into the folded configuration.

FIG. 5 shows a top-down view of the foldable carry cot 100 after the foldable sidewalls 140 have been unfastened from the second releasable locking mechanism 124, 125.

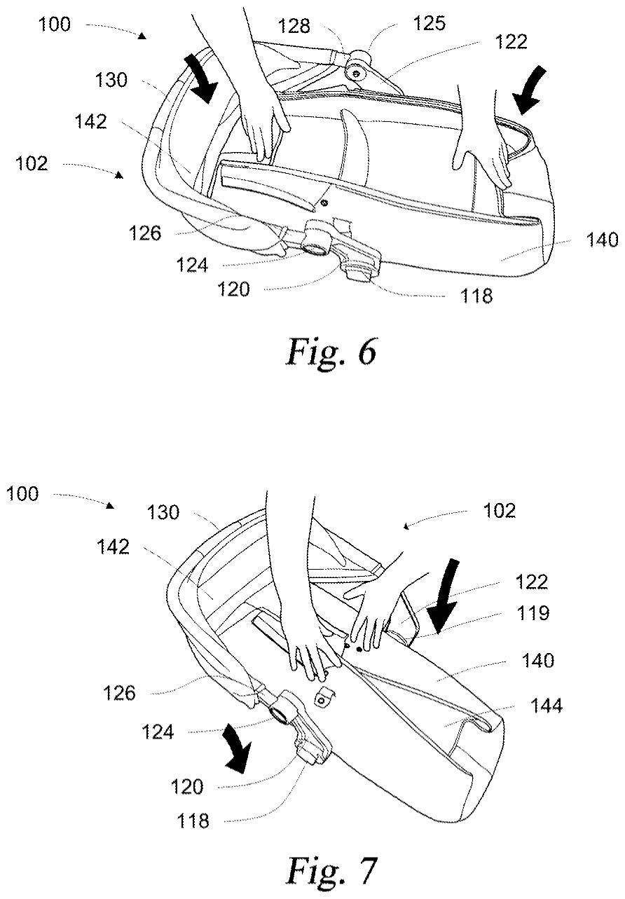

FIG. 6 shows an isometric view of the foldable carry cot 100 as end wall portions of the sidewalls 140 are being folded. Expressed differently, the pair of opposing end wall portions are folded inwardly onto the base member 110 (i.e. to lie substantially flat to an upper surface of the mattress 144). The cover 146 that had been unzipped but not removed in FIG. 5 has been removed in FIG. 6.

FIG. 7 shows an isometric view of the foldable carry cot 100 as side wall portions of the sidewalls 140 are being folded over the end wall portions. Expressed differently, the pair of opposing side wall portions are folded inwardly onto the opposing end wall portions (i.e. to lie substantially flat to an upper surface of the mattress 144).

The recess in the base member 110 is suitable for at least partially accommodating the foldable reinforced sidewalls 140 when in the folded configuration.

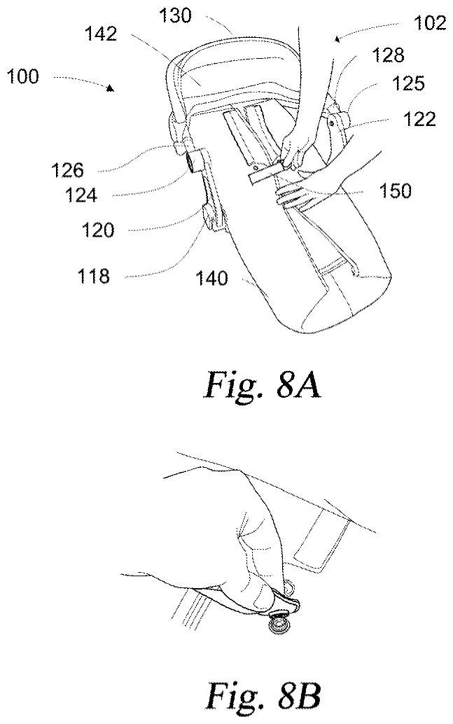

FIGS. 8A and 8B show an isometric view of fastening the side wall portions of the foldable carry cot 100 together using the fastening means in the form of the pop rivet 150. The side wall portions are fastened together by closing the pop rivet such that the sidewalls 140 cannot unfold. FIG. 8A shows a full view and FIG. 8B shows an enlarged view of the pop rivet 150 for fastening the side wall portions together.

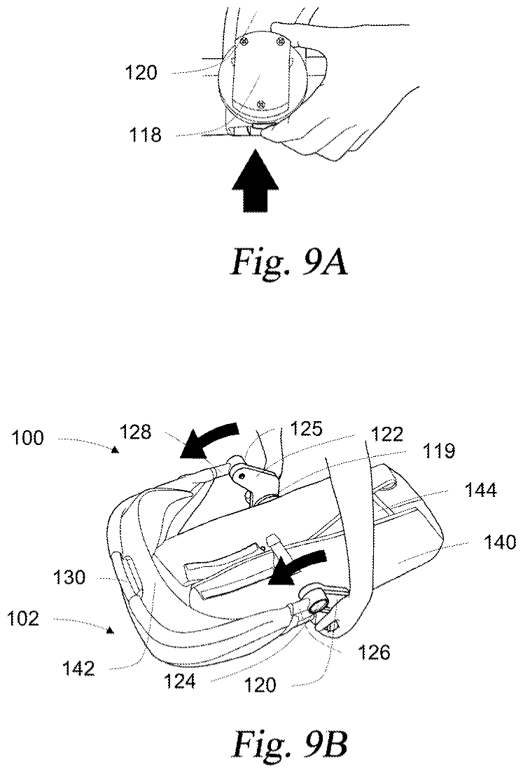

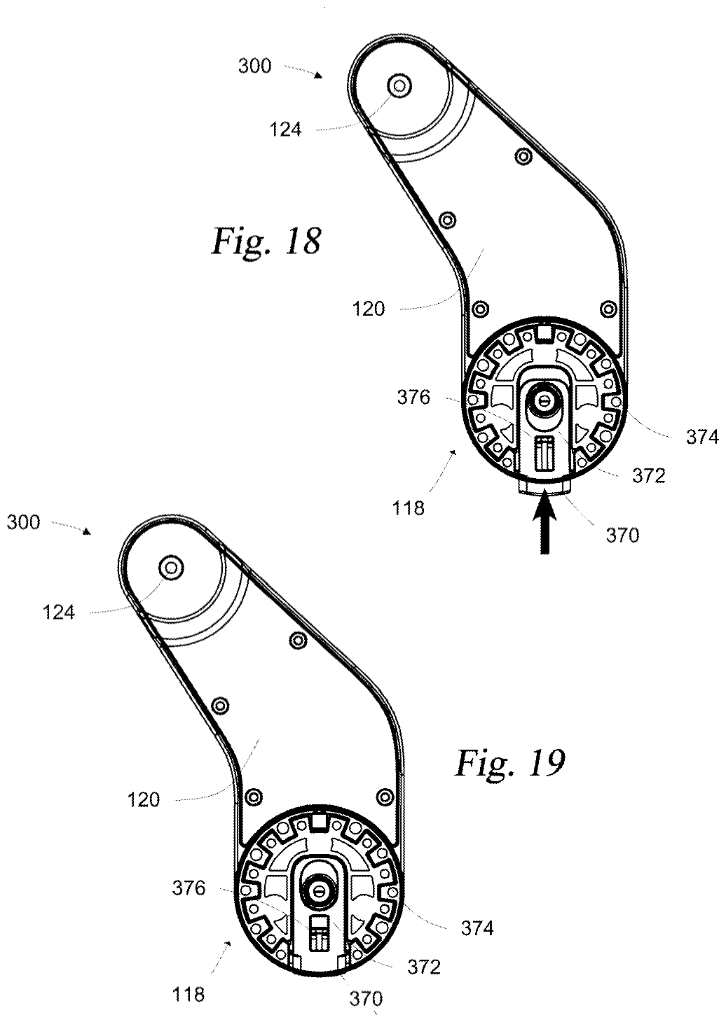

FIGS. 9A and 9B show an isometric view of releasing a first releasable locking mechanism 118, 119 of the foldable carry cot 100 and moving first 120 and second 122 arms of the present invention. FIG. 9B shows a full view and FIG. 9A shows an enlarged view of the first releasable locking mechanism 118, 119. The first releasable locking mechanism 118, 119 is released or locked using a push-release button. This mechanism is described in further detail in relation to FIGS. 18 and 19.

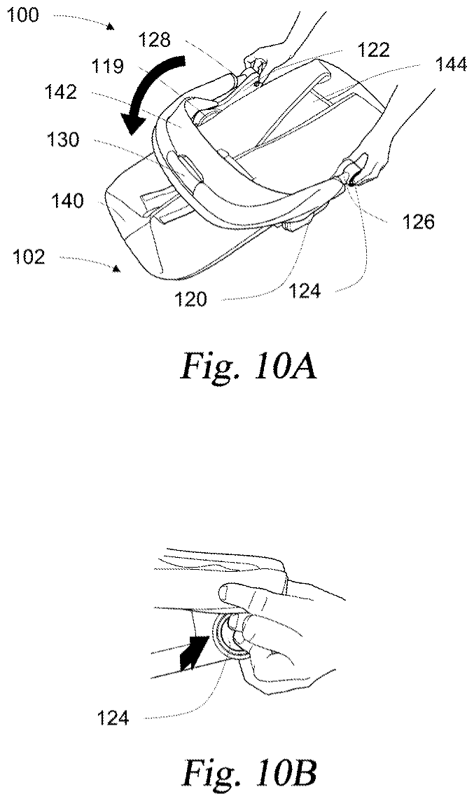

FIGS. 10A and 10B show an isometric view of releasing the second releasable locking mechanism 124, 125 of the foldable carry cot 100 to rotate (in the direction indicated by the arrow) the third 126 and fourth 128 arms relative to the first 120 and second 122 arms respectively, after the first 120 and second 122 arms of the present invention have been moved. FIG. 10A shows a full view and FIG. 10B shows an enlarged view of the first releasable locking mechanism 118, 119.

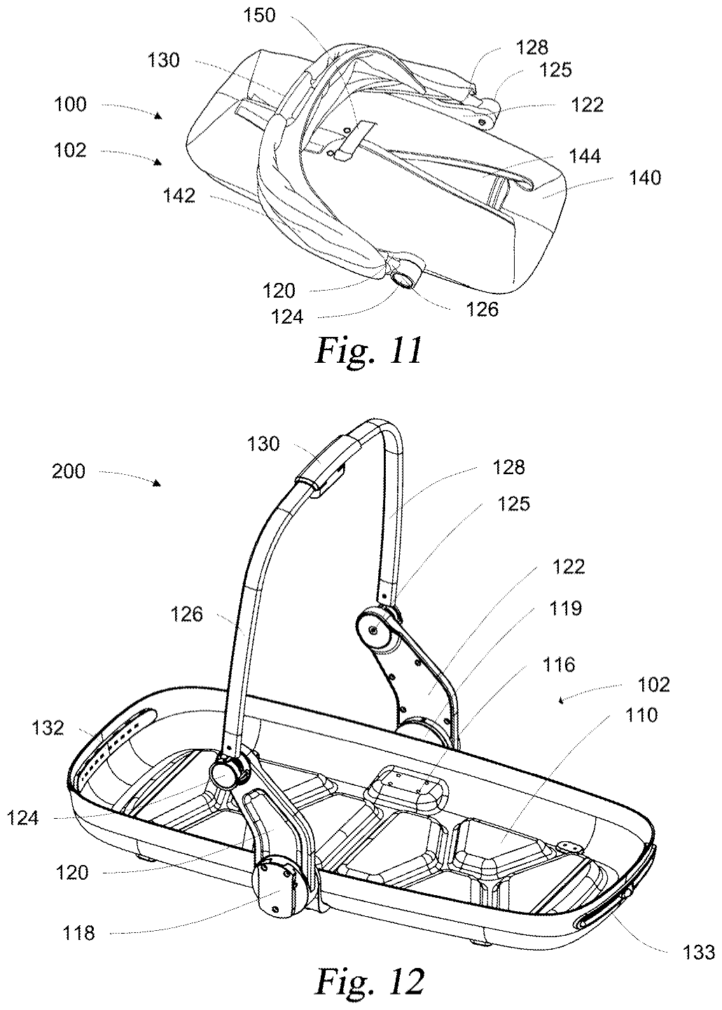

FIG. 11 shows an isometric view of the foldable carry cot 100 in the folded configuration. In the folded configuration, the foldable sidewalls 140 have been folded inwardly such that the foldable sidewalls 140 are substantially flat to the base member 110. The double pivot of the hood member 102 in combination with the angled arrangement of the first 120 and second 122 arms enables the third 126 and fourth 128 arms to pivot backwards relative to the first arm 120 and the second arm 122 such that the third 126 and fourth 128 arms lie substantially parallel to the base member 110. This improves storing and/or transporting of the foldable carry cot 100. Additionally, in the folded configuration, the handle 130 lies flat to (i.e. makes contact with) the foldable sidewalls 140 (i.e. which are folded) and the foldable hood 142 folds between the handle 130 and the foldable sidewalls 140.

FIG. 12 shows an isometric view of the foldable carry cot 100 without the foldable sidewalls 140, foldable hood 142, mattress 144 or cover 146, such that movement of the present invention between the folded and the functional configuration can be better understood. In FIG. 12 the foldable carry cot is shown in the functional configuration with the handle extending upwardly above the base member 110.

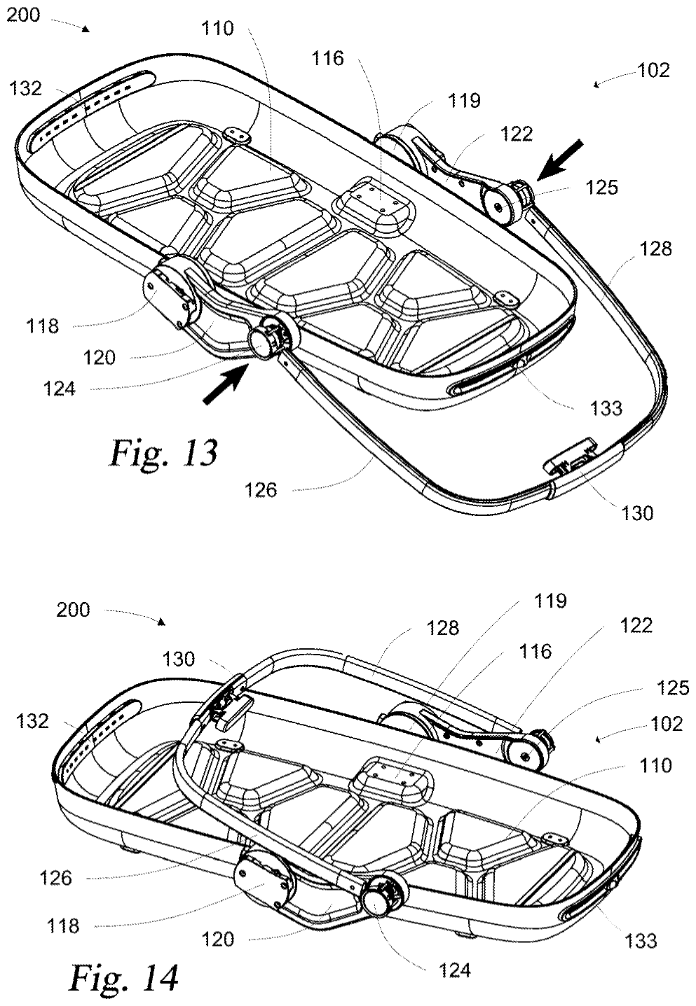

FIG. 13 shows an isometric view of the foldable carry cot 100 of FIG. 12 in a partially-folded configuration. The partially folded configuration is between the functional configuration and the folded configuration. In the partially folded configuration, the first 120 and second 122 arms have been moved using the first releasable locking mechanism 118, 119 such that the first 120 and second 122 arms are parallel to the base member. The third 126 and fourth 128 arms are arranged in substantially the same direction as the first 120 and second 122 arms.

FIG. 14 shows an isometric view of the foldable carry cot 100 of FIG. 12 in a folded configuration. FIG. 14 is identical to FIG. 13, except that in FIG. 14 the third 126 and fourth 128 arms have been rotated at the second releasable locking mechanism 124, 125 to be substantially antiparallel to the first 120 and second 122 arms. Expressed differently, the double pivot in combination with the angled arrangement of the first 120 and second 122 arms enables the third 126 and fourth 128 arms to pivot backwards relative to the first arm 120 and the second arm 122 such that the third 126 and fourth 128 arms lie substantially parallel to the base member 100 (but the first 120 and second 122 arms lie substantially antiparallel to the third 126 and fourth 128 arms).

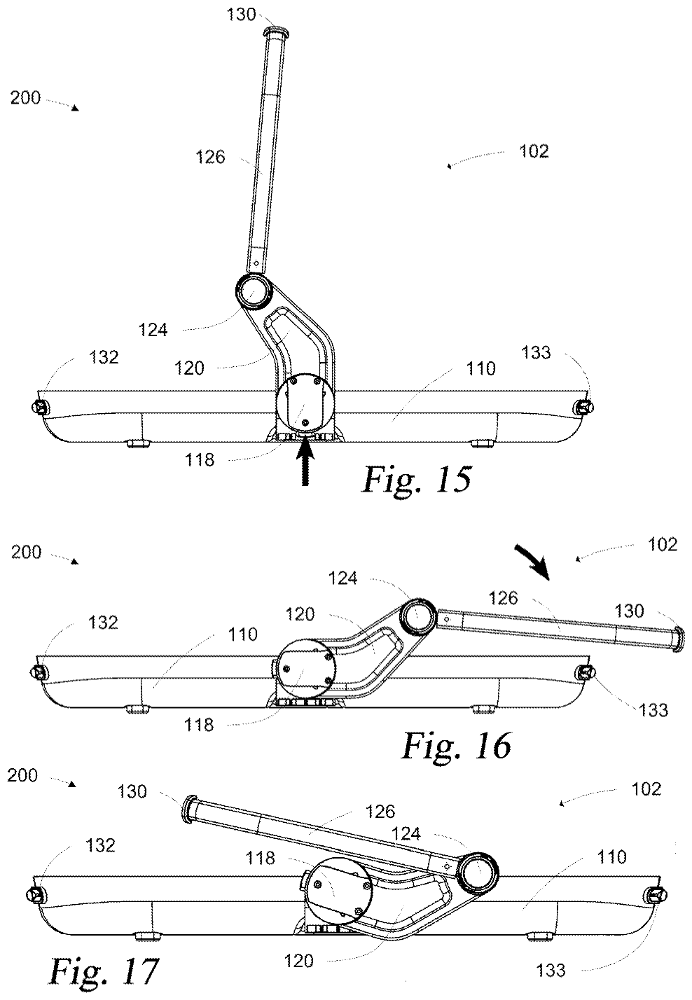

FIG. 15 shows a side view of the foldable carry cot 100 of FIG. 12.

FIG. 16 shows a side view of the foldable carry cot 100 of FIG. 13.

FIG. 17 shows a side view of the foldable carry cot 100 of FIG. 14.

FIG. 18 shows an enlarged side view of the first arm 120 and first releasable locking mechanism 118 in a locked state. The first releasable locking mechanism 118 comprises a locking release, wherein actuation of the locking release releases the hood member 102. The locking release comprises a locking pin 372. The locking pin 372 is biased towards an engaged position that locks the hood member 102 in the locked position. The locking pin 372 is biased towards the engaged position by means of a spring 376.

The first releasable locking member 118 further comprises a locking member configured to engage with the locking pin 372 in the engaged position, and to disengage from the locking pin 372 upon actuation of the locking release such that the hood member 102 is released. The locking member comprises a gear wheel 374 that is arranged co-axially with the pivotal connection between the hood member 102 and the base member 110. The gear wheel 374 comprises a plurality of teeth arranged on an inner circumferential surface of the gear wheel 374.

Expressed differently, in FIG. 18, the push-release button 370 is in a released state; consequently, the first releasable locking mechanism is in the locked state.

FIG. 19 shows an enlarged side view of the first arm 120 and first releasable locking mechanism 118 in an unlocked state. FIG. 19 is identical to FIG. 18, except because the push-release button 370 has been pressed, the spring 372 has been compressed enabling the locking pin 372 to disengage with the gear wheel 374. This enables rotation of the gear wheel such that the hood member 102 is released.

Expressed differently, in FIG. 19, the push-release button 370 is in a pressed state; consequently, the first releasable locking mechanism is in the released state.

The second releasable locking mechanism 124, 125 is as defined in relation to FIGS. 18 and 19.

1. A foldable carry cot for carrying an infant, the foldable carry cot comprising:
a base member;
a foldable sidewall flexibly coupled to the base member, the foldable sidewall being configured to move between a functional configuration that provides a sidewall to the foldable carry cot such that the foldable carry cot is suitable carrying an infant, and a folded configuration wherein the foldable sidewall is configured to fold inwardly.

2. A foldable carry cot according to claim 1, wherein the foldable sidewall in the functional configuration is absent of folds or creases to provide a continuous inner surface.

3. A foldable carry cot according to claim 1, wherein the foldable sidewall is coupled to the base member to provide tension in the foldable sidewall such that the foldable sidewall is freely upstanding from the base member in the functional configuration.

4. A foldable carry cot according to claim 1, wherein the foldable sidewall is irreversibly secured to the base member.

5. A foldable carry cot according to claim 1, wherein the foldable sidewall is precluded from folding outwardly.

6. A foldable carry cot according to claim 1, wherein the foldable sidewall comprises
a pair of opposing end wall portions;
a pair of opposing side wall portions; and
wherein each of the end wall portions and side wall portions are flexibly coupled to the base member.

7. A foldable carry cot according to claim 6, wherein the pair of opposing end wall portions are configured to fold inwardly onto the base member, and the pair of opposing side wall portions are configured to fold onto the opposing end wall portions.

8. A foldable carry cot according to claim 1, wherein the foldable sidewall is reinforced, such that in the functional configuration the sidewalls are upstanding relative to the base member to provide the carry cot sidewalls.

9. A foldable carry cot according to claim 1, comprising fastening means for securing the foldable sidewall in the folded configuration.

10. A foldable carry cot according to claim 1, wherein the foldable sidewall comprises a continuous fabric sheet flexibly coupled to the base member, optionally wherein the continuous fabric sheet is constructed from at least two sheets of fabric, such that the continuous fabric sheet has at least one pocket between the at least two sheets of fabric, optionally wherein the at least one pocket is configured to accommodate at least one reinforcing member, optionally wherein the foldable sidewall comprises:
a pair of opposing end wall portions including a first end wall portion and a second end wall portion, wherein the first end wall portion comprises a first end wall reinforcing member in a first end wall pocket, and the second end wall portion comprises a second end wall reinforcing member in a second end wall pocket;
a pair of opposing side wall portions, including a first side wall portion and a second side wall portion, wherein the first side wall portion comprises a first side wall reinforcing member in a first side wall pocket, and the second side wall portion comprises a second side wall reinforcing member in a second side wall pocket; and
wherein each of the end wall portions and side wall portions are flexibly coupled to the base member.

11. A foldable carry cot according to claim 1 further comprising a hood member, the hood member being pivotally connected to the base member, optionally wherein the hood member comprises a foldable hood, optionally wherein the foldable hood comprises a fabric, optionally further comprising fastening means for securing the hood to the foldable side wall and/or to the base member, optionally wherein the hood member comprises a first arm and a second arm, wherein the first arm and second arm are each pivotally connected to the base member such that the first arm and second arm can pivot relative to the base member, optionally wherein the first arm and second arm are arranged on opposing sides of the base member.

12. A foldable carry cot according to claim 11, wherein the first arm and the second arm each have an angled arrangement, such that a first end of the first arm is offset relative to a second end of the first arm that is pivotally connected to the base member, and such that a first end of the second arm is offset relative to a second end of the second arm that is pivotally connected to the base member.

13. A foldable carry cot according to claim 11, wherein the hood member further comprises a third arm pivotally connected to the first arm, and a fourth arm pivotally connected to the second arm, such that the third arm can pivot relative to the first arm and the fourth arm can pivot relate to the second arm, optionally wherein the third arm and fourth arm are connected to provide a handle.

14. A foldable carry cot according to claim 11, further comprising a releasable locking mechanism, the releasable locking mechanism being configured to lock the hood member in a locked position, and to release the hood member such that the hood member can pivot relative to the base member, optionally wherein the releasable locking mechanism comprises a locking release, wherein actuation of the locking release releases the hood member, optionally wherein locking release comprises a locking pin, optionally wherein the locking pin is biased towards an engaged position that locks the hood member in the locked position, optionally wherein the locking pin is biased towards the engaged position by means of a spring, optionally wherein the releasable locking member further comprises a locking member configured to engage with the locking pin in the engaged position, and to disengage from the locking pin upon actuation of the locking release such that the hood member is released, optionally wherein the locking member comprises a gear wheel, optionally wherein the gear wheel is arranged co-axially with the pivotal connection between the hood member and the base member.

15. A foldable carry coat according to claim 14, wherein the gear wheel comprises a plurality of teeth arranged on an inner circumferential surface of the gear wheel.

16. A foldable carry cot, further comprising a second releasable locking mechanism, the second releasable locking member being configured to lock the position of the third arm and fourth arm relative to the first arm and second arm, and to release the third arm and the fourth arm such that the third arm and fourth arm can pivot relative to the first arm and second arm, optionally wherein the second releasable locking mechanism is as defined in claim 14, optionally wherein the second releasable locking mechanism comprises a push-release button.

17. A foldable carry cot according claim 11, further comprising fastening means for securing the foldable sidewall to the hood member.

18. A foldable carry cot according to claim 1, wherein the base member comprises a rigid base member, optionally wherein the base member comprises a peripheral lip extending upwardly from the base member to define a recess, optionally wherein the recess is suitable for accommodating a mattress for an infant, optionally wherein the recess is suitable for at least partially accommodating the foldable reinforced sidewall when in the folded configuration.

19. A foldable carry cot according to claim 1, further comprising a cover member, the cover member being connected to the flexible sidewalls and suitable for providing cover to at least a portion of the infant in the functional configuration; wherein the cover member comprises a fabric; and
wherein the foldable carry cot further comprises fastening means for securing the cover member to the foldable sidewall.

20. A foldable carry cot for carrying an infant, the foldable carry cot comprising:
a base member; and
a hood member; wherein the hood member comprises a first arm and a second arm, wherein the first arm and second are each pivotally connected to the base member such that the first arm and second arm can pivot relative to the base member,
the hood member further comprising a third arm pivotally connected to the first arm, and a fourth arm pivotally connected to the second arm, such that the third arm can pivot relative to the first arm and the fourth arm can pivot relate to the second arm, optionally wherein the first arm and the second arm each have an angled arrangement, such that a first end of the first arm is offset relative to a second end of the first arm that is pivotally connected to the base member, and such that a first end of the second arm is offset relative to a second end of the second arm that is pivotally connected to the base member.
